(19) United States
(12) Patent Application Publication
(10) Pub. No.: US 2008/0265199 A1
(43) Pub. Date: Oct. 30, 2008

(54) ZERO LEAKAGE BALANCE VALVE SYSTEM

(75) Inventors: Ercio Lutkemeyer, Caxias do Sul (BR); Adriano Nunes Garcia, Caxias do Sul (BR)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/739,465

(22) Filed: Apr. 24, 2007

(51) Int. Cl. F16K 39/00

(52) U.S. Cl. 251/282

(57) ABSTRACT

A valve assembly for a hydraulic device. The valve assembly has a valve seat within a valve passageway used in combination with a spool. The spool has a first section wherein a flexible element is disposed within a cavity of the first section such that in a first position the spool and specifically the flexible element engages the valve seat to provide zero leakage from the valve passageway into a tank passageway. Additionally, the spool is designed to have an additional section at a second end to provide equal sealing areas at both the first and second ends of the spool to balance the forces within the valve passageway.

### BACKGROUND OF THE INVENTION

This invention relates to valve assemblies for hydraulic devices. More specifically, this invention relates to a zero leakage balance valve system.

Hydraulic systems requiring among others load holding capabilities have always been a need in a variety of applications. Examples include the three point hitch on tractors. The need is to hold a load at a constant position relative to the tractor in any preselected hitch position. Currently, hydraulic valve systems which typically use metal to metal seals are not able to completely meet this need as leakage around check valves and lowering valves in the assemblies cause the load to drift down.

Pressure/force balance spool valves of the state of the art technology in hitch-type valves require high precision manufacturing of the spool and seat in order to accomplish a balance of forces. Due to typical manufacturing tolerances, however, providing this balance cannot be accomplished for the desired need in the art.

Attempts have been made to use a flexible seal within a housing to improve leakage to overcome problems associated in the art. However, the flexible seal is fixed on the housing creating manufacturing difficulties and operational difficulties. Such flexible sealing members have been ineffective in solving all the problems in the state of the art.

Thus, it is a principle object of the present invention to provide an improved valve assembly that provides for zero leakage.

Yet another object of the present invention is to provide for a valve assembly that provides a force balance system that facilitates the manufacturing process.

These and other objects, features, or advantages of the present invention will become apparent from the specification and the claims.

### BRIEF SUMMARY OF THE INVENTION

A valve assembly for hydraulic device comprising a housing having an inlet passageway and a tank passageway disposed therein. Additionally, the housing has a valve passageway that is in fluid communication between the inlet passageway and the tank passageway. A valve seat is disposed within the valve passageway and has a first end adjacent the tank passageway and extends to a second end and has a first tapered surface at the first end. A spool is disposed within the valve seat and has a first spool section at a first end and extends to a second end wherein the first spool section has a cavity therein that receives a flexible element disposed around the first spool section. Thus, when the spool is in a first position, the flexible element of the valve spool engages the first tapered section of the valve seat to seal and thus prevent fluid flow communication between the inlet passageway and the tank passageway and wherein in a second position of the spool the flexible element of the spool is detachably disposed within the valve seat to allow fluid flow communication between the inlet passageway and the tank passageway.

### BRIEF DESCRIPTION OF THE DRAWINGS

FIG. 1 is a sectional view of a valve assembly for a hydraulic device;

FIG. 2 is a sectional view of a spool within a valve seat in a first position;

FIG. 3 is a sectional view of a spool within a valve seat in a second position within a valve assembly; and

FIG. 4 is a side plan view of a spool of a valve assembly.

### DETAILED DESCRIPTION OF THE PREFERRED EMBODIMENT

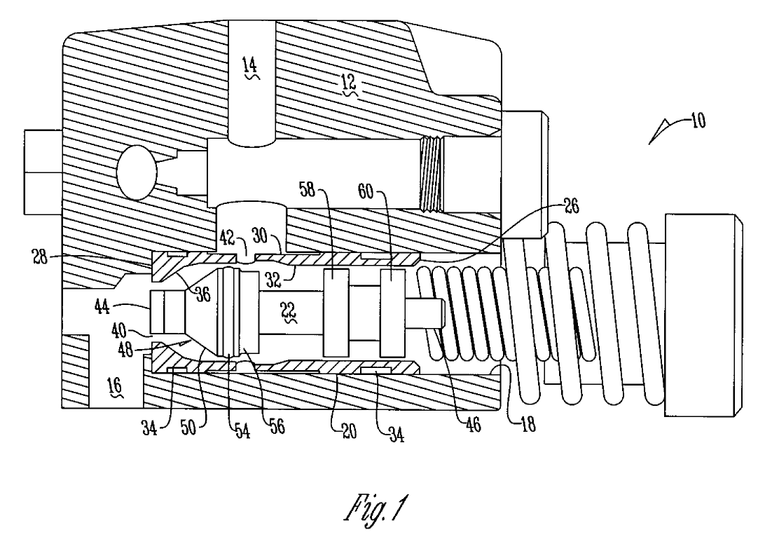

FIGS. 1-3 show a valve assembly 10 for a hydraulic device. Though the valve assembly is shown as a rock shaft valve (RCV) the valve assembly 10 may also be used with other hitch valves, check valves that requires zero leakage, counter balance valves, and the like. The valve assembly 10 has a housing 12 with an inlet passageway 14 and a tank passageway 16 disposed therein. A valve passageway 18, which in this embodiment is oriented at a right angle to both the inlet passageway 14 and tank passageway 16 is also disposed through the housing 12 and provides a fluid flow communication path between the inlet passageway 14 and valve passageway 18. Disposed within the valve passageway 18 is a valve seat 20 that works in combination with spool 22 to control the flow between the inlet passageway 14 and tank passageway 16. Though described as a spool 22, in another embodiment the spool 22 may be a check poppet.

The valve seat 20 extends from a first end 24 adjacent the tank passageway 16 to a second end 26 wherein a seating element 28 contacts the housing 12 at the first end 24 to retain the valve seat 20 therein. The valve seat 20 additionally has an outer and inner surface 30 and 32 respectively. The outer surface 30 contains a plurality of cavities 34 therein whereas the inner surface 32 has a tapered surface 36 at the first end 24 of the valve seat 20. Additionally, at the first end 24 of the valve seat 20 is a first opening 40 that works in combination with a second opening 42 to provide a fluid flow path from the inlet passageway 14 to the tank passageway 16. Additionally, there is a load pressure gallery created at the second opening 42.

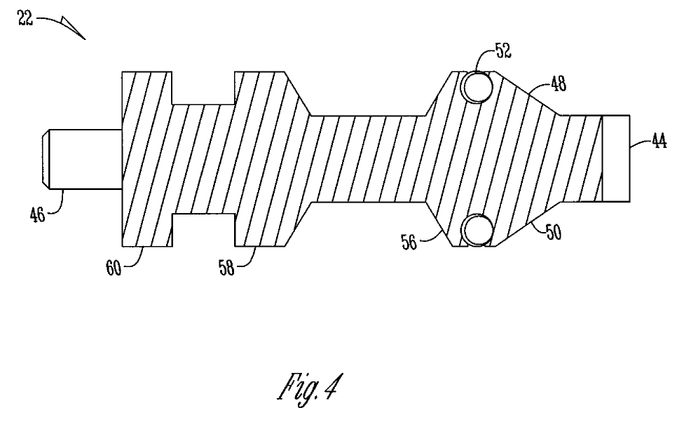

The spool 22 extends from a first end 44 to a second end 46. Adjacent the first end 44 of the spool 22 is a first spool section 48. The first spool section 48 in one embodiment has a first tapered surface 50 that in a first position mates with the tapered surface 36 of the valve seat 20. The first tapered surface 50 terminates in a cavity 52 disposed around the first spool section 48. The cavity 52 receives a flexible element 54 and in a preferred embodiment as best shown in FIG. 4 the cavity 52 is crimped to secure the flexible element 54. In one embodiment the flexible element is an O-ring. Extending from the cavity 52 is a second surface 56 that in one embodiment is a tapered surface wherein the first tapered surface 50 and the second surface 56 sandwich the flexible element 54 therein.

Adjacent the second end 46 of the spool 22 are second and third spool sections 58 and 60. The second and third spool sections 58 and 60 act to seal the second end 46 of the spool 22. Specifically, the sealing diameter can be machined in one embodiment to accomplish the same sealing diameter at both the first and second ends 44 and 46 of the spool 22. Consequently, the same load area A1=A2 is provided at both the first and second ends 44 and 46 of the spool 22.

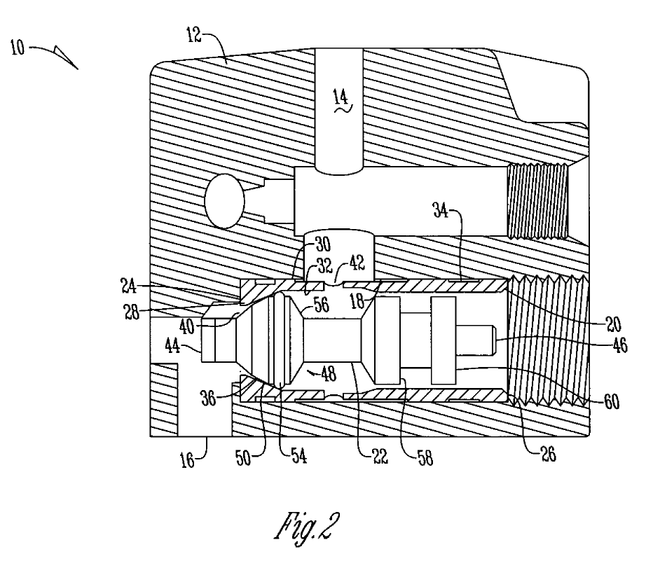

In operation when a load is acting upon the spool 22 the spool is in a first position that is considered a closed or load position as best shown in FIG. 2. In this position the first tapered surface 50 of the spool 22 engages the tapered surface 36 of the valve seat 20 and the flexible element 54 additionally engages the inner surface 32 of the valve seat 20 to seal or prevent fluid flow communication between the inlet passageway 14 and the tank passageway 16. Thus, the flexible element 54 acts as a seal to ensure that zero leakage of fluid from the valve passageway 18 into the tank passageway 16 is present. Additionally, because the areas A1 and A2 are equal the system stays balanced when the pressure in the system is constant as force=pressure*area. Consequently, the flexible element 54 is able to continue to provide a zero leakage condition. Thus, the spool 22 is considered to provide balanced pressure or is considered pressure force balanced.

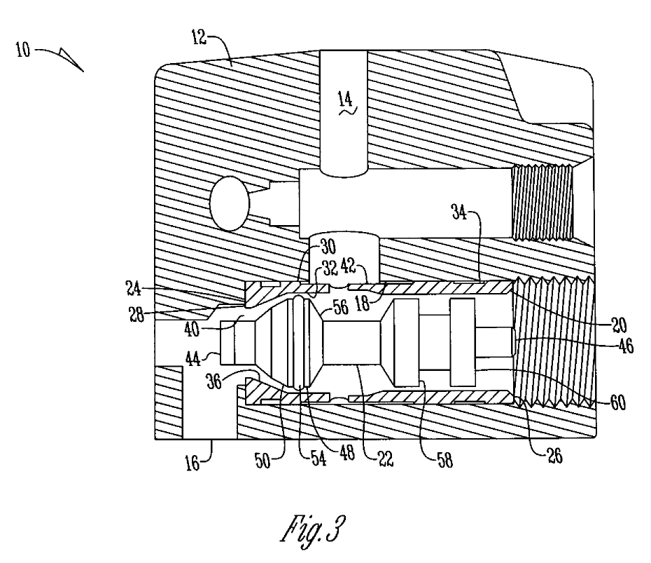

In a second position or an open position as shown in FIG. 3 the spool 22 is positioned such that the first spool section 48 and flexible element 54 are detachably disposed within the valve seat 20. This position allows fluid flow communication between the inlet passageway 14 and the tank passageway 16.

Thus, by having a crimped cavity 52 in combination with the use of flexible element 54 therein the first spool section 48 avoids the extrusion of the flexible sealing element 54 when there is oil flow. This in part is a result of the flexible element 54 being attached to the spool 22. Therefore, the valve assembly 10 provides a zero leakage valve that can be used in a plurality of applications such as used with a load holding device. Similarly, the zero leak valve assembly 10 can be used as both a load holding device and as a lowering valve for a tractor hitch valve specifically, a hydraulic mechanical rock shaft valve. In yet another embodiment the load holding valve assembly 10 has a spool 22 within a load holding valve of a rock shaft valve that is pressure forced balanced. In yet another embodiment the zero leak valve assembly 10 is a load holding device and also is a counter balance valve or over centre valve. Thus, by using the spool or poppet 22 described the valve assembly 10 can be used in a plurality of applications, provides for zero leakage, and this is accomplished through pressure forced balance due to the design of the valve seat 20 and valve spool 22. Therefore, at the very least all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A valve assembly for a hydraulic device comprising:
a housing having an inlet passageway and a tank passageway disposed therein;
a valve passageway in fluid communication between the inlet passageway and tank passageway;
a valve seat disposed within the valve passageway having a first end adjacent the tank passageway extending to a second end and having a tapered surface at the first end;
a spool disposed within the valve seat having a first spool section at a first end and extending to a second end wherein the first spool section has a cavity therein that receives a flexible element disposed around the first spool section;
wherein in a first position of the spool the flexible element of the spool engages the tapered section of the valve seat to prevent fluid flow communication between the inlet passageway and tank passageway; and
wherein in a second position of the valve spool the flexible element of the valve spool is detachably disposed within the valve seat to allow fluid flow communication between the inlet passageway and the tank passageway.

2. The valve assembly of claim 1 wherein the cavity of the first spool section of the spool is crimped to secure the flexible element within the spool.

3. The valve assembly of claim 1 wherein the flexible element is an O-ring.

4. The valve assembly of claim 1 wherein the first spool section has a first tapered surface that engages the tapered section of the valve seat when the valve spool is in the first position.

5. The valve assembly of claim 1 wherein the valve spool has a second spool section having a diameter and wherein the flexible element has a diameter wherein the diameter of the second section is equal to the diameter of the flexible element.

6. The valve assembly of claim 1 wherein the first end of the spool is associated with a first area and the second end of the spool is associated with a second area wherein the first area equals the second area.

7. The valve assembly of claim 6 wherein the force created by pressure over the first and second areas balances such that the spool does not move.

8. The valve assembly of claim 1 wherein the valve seat has an opening therein to provide a load pressure gallery.

9. The valve assembly of claim 1 wherein the valve assembly is a load holding device.

10. The valve assembly of claim 1 wherein the valve assembly is a zero leak valve that is used as both a load holding device and as a lowering valve for a tractor hitch valve.

11. The valve assembly of claim 10 wherein the zero leak valve is a hydraulic mechanical rock shaft valve.

12. The valve assembly of claim 1 wherein the load holding valve assembly has the spool within a load holding valve of a rock shaft valve that is pressure forced balanced.

13. The valve assembly of claim 1 wherein the valve assembly is a load holding device and also is a counter balance valve.

14. The valve assembly of claim 1 wherein the valve assembly is a load holding device and also is an over centre valve.
